(19) United States
(12) Patent Application Publication
(10) Pub. No.: US 2014/0372342 A1
(43) Pub. Date: Dec. 18, 2014

(54) SYSTEM AND METHOD FOR AUTOMATED MARKET MAKING

(71) Applicants: Yiling Chen, Cambridge, MA (US); Jennifer Wortman Vaughan, Venice, CA (US); Jacob Duncan Abernethy, Ann Arbor, MI (US)

(72) Inventors: Yiling Chen, Cambridge, MA (US); Jennifer Wortman Vaughan, Venice, CA (US); Jacob Duncan Abernethy, Ann Arbor, MI (US)

(73) Assignees: The Regents of the University of California, Oakland, CA (US); President and Fellows of Harvard College, Cambridge, MA (US)

(21) Appl. No.: 14/116,163

(22) PCT Filed: May 7, 2012
(86) PCT No.: PCT/US12/36724

§ 371 Date: Feb. 26, 2014

Related U.S. Application Data
(60) Provisional application No. 61/484,880, filed on May 11, 2011.

(51) Int. Cl. G06Q 40/06

(52) U.S. Cl. CPC G06Q 40/06
USPC 705/36 R

(57) ABSTRACT

Method and systems for design and operation of a prediction market. A plurality of security bundles and a plurality of payoff vectors may be defined, such that each payoff vector in the plurality of payoff vectors is associated with at least one outcome in a plurality of outcomes. A prediction market engine may be provided for determining a price for each security bundle in the plurality of security bundles by using at least one processor to minimize a convex function over a convex set comprising a convex hull of the plurality of payoff vectors.

### CROSS-REFERENCE TO RELATED APPLICATIONS

The present application claims the benefit under 35 U.S.C. §119(e) of U.S. Provisional Application Ser. No. 61/484,880, filed on May 11, 2011, titled, “System and Method for Automated Market Making,” which is hereby incorporated by reference in its entirety.

### FEDERALLY SPONSORED RESEARCH

This invention was made with government support under CCF-0953516; CIF-246 awarded by the NSF; Computing Research Association. The government has certain rights in the invention.

### BACKGROUND

Prediction markets play a fundamental role in economics and finance. A prediction market provides a central place where people may converge to place orders, such as a betting market for placing bets on the outcome of an event or a financial market for placing orders for trading commodities or securities. A prediction market offers a set of contingent securities whose payoffs depend on the future state of the world. One example of a contingent security is an Arrow-Debreu security, which pays $1 if a particular state of the world is reached and pays $0 otherwise. Other examples of contingent securities include insurance policies, options, futures, and many other financial derivatives.

In many real-world settings, there may be an exponentially large or even infinite set of future states of the world that may be of interest to prediction market participants, and on whose occurrence they may wish to bet. The future price of a stock or a bond, for instance, may take on a very large or even infinite set of values. Another example concerns predicting the result of a competition among N candidates. Assuming that there are no ties, there are N*(N−1)*(N−2)* . . . *2*1 (i.e., N! or N factorial) possible outcomes, with each outcome corresponding to a ranking of the N candidates at the end of the competition. The number of outcomes in this prediction market is, therefore, an exponential function of N—allowing market participants to place bets on any one of these many outcomes is impractical. Indeed, it is computationally intractable to maintain a set of securities such that each future outcome has a corresponding security. Such a strategy would require storing and pricing an exponentially large or even infinite number of securities and is not feasible.

Prediction market participants are often interested in purchasing a security bundle—a contract that simultaneously covers one or multiple outcomes. Buying such a security bundle amounts to simultaneously betting on one or more outcomes. In the ranking prediction market, for instance, one may place a bet on any one of the N! rankings. However, it is also desirable to place bets on sets of outcomes such as “candidate A finishes before candidate B,” without explicitly betting on the exact positions of A, B, and the remaining candidates. This type of security bundle covers exponentially many outcomes in the number of candidates.

### SUMMARY

In some embodiments, a computer-implemented method of designing a prediction market is disclosed. The method comprises defining a plurality of security bundles and a plurality of payoff vectors, wherein each payoff vector in the plurality of payoff vectors is associated with an outcome in a plurality of outcomes. The method further comprises determining, using at least one processor, a price for each security bundle in the plurality of security bundles by using at least one processor to minimize a convex function over a convex set comprising a convex hull of at least one vector in the plurality of payoff vectors.

In some embodiments, at least one non-transitory computer-readable storage medium is disclosed. The at least one non-transitory computer-readable storage medium stores processor-executable instructions that, when executed by at least one processor, cause the at least one processor to perform a method of determining a price for each security bundle in a plurality of security bundles. The method comprises minimizing a convex function over a convex set comprising a convex hull of a plurality of payoff vectors, wherein each payoff vector in the plurality of payoff vectors is associated with an outcome in a plurality of outcomes.

In some embodiments, a computer-implemented method of operating a prediction market is disclosed. The method comprises presenting, using at least one processor, a plurality of security bundles together with a price for each security bundle to a plurality of prediction market participants; receiving, using the at least one processor, an order from a participant in the plurality of prediction market participants; and sending, using the at least one processor, a response to the participant notifying the participant that the order has been accepted. Each payoff vector in a plurality of payoff vectors is associated with at least one outcome in a plurality of outcomes and the price for each security bundle is determined by using the at least one processor to minimize a convex function over a convex set comprising a convex hull of the plurality of payoff vectors.

In some embodiments, a system for operating prediction a market is disclosed. The system comprises at least one processor configured to calculate a price for each security bundle in a plurality of security bundles by minimizing a convex cost function over a convex set comprising a convex hull of the plurality of payoff vectors, wherein each payoff vector in the plurality of payoff vectors is associated with an outcome in a plurality of outcomes. The at least one processor is further configured to output the plurality of security bundles together with the corresponding prices to a plurality of prediction market participants and receive an order from a participant in the plurality of prediction market participants, wherein the system is configured to output a response to the participant notifying the participant that the order has been accepted.

The foregoing is a non-limiting summary of the invention, which is defined by the attached claims.

### BRIEF DESCRIPTION OF THE DRAWINGS

FIG. 1 shows an illustrative set of security bundles, in accordance with some embodiments;

FIG. 2 shows an illustrative payoff structure for a set of security bundles in a prediction market, in accordance with some embodiments;

FIG. 3 shows an illustrative payoff structure for another set of security bundles in a prediction market, in accordance with some embodiments;

FIG. 4 shows an exemplary system 400 for trading security bundles, in accordance with some embodiments; and

FIG. 5 shows an illustrative implementation of a computer system that may be used in connection with some embodiments.

### DETAILED DESCRIPTION

The inventors have recognized that conventional approaches to designing and operating prediction markets in the above-described setting, which includes pricing all securities of interest, have not yielded markets that can be practically implemented in many real-world situations—either the computational complexity of operating such markets is too high (e.g., exponential in the number of securities) or the resultant markets have undesirable properties (e.g., the institution operating the market, sometimes called the market-maker, can sustain unbounded losses). Accordingly, the inventors have recognized and appreciated the need for a system and method for designing and efficiently operating prediction markets, which may allow market participants to trade an arbitrary set of securities.

The inventors have recognized that pricing security bundles, each of which may be associated with one or multiple outcomes, does not have to rely on the conventional approach of pricing each individual outcome, of which there may be a very large number, and aggregating the results. Further, the inventors have appreciated that security bundle prices may be obtained directly by using efficient convex optimization techniques. The inventors have recognized that such pricing techniques enable the design and operation of a wide variety of prediction markets, whose implementation was infeasible using conventional methods. Accordingly, in some embodiments, techniques for designing and operating one or more prediction markets using security bundles are provided as described in more detail below.

An automated market maker is a market institution that may adaptively set prices for each security and may accept trades at the current prices. A market maker may be interested in designing and operating prediction markets which allow participants to place bets on security bundles that allow market participants to bet simultaneously on one or multiple future states of the world (outcomes).

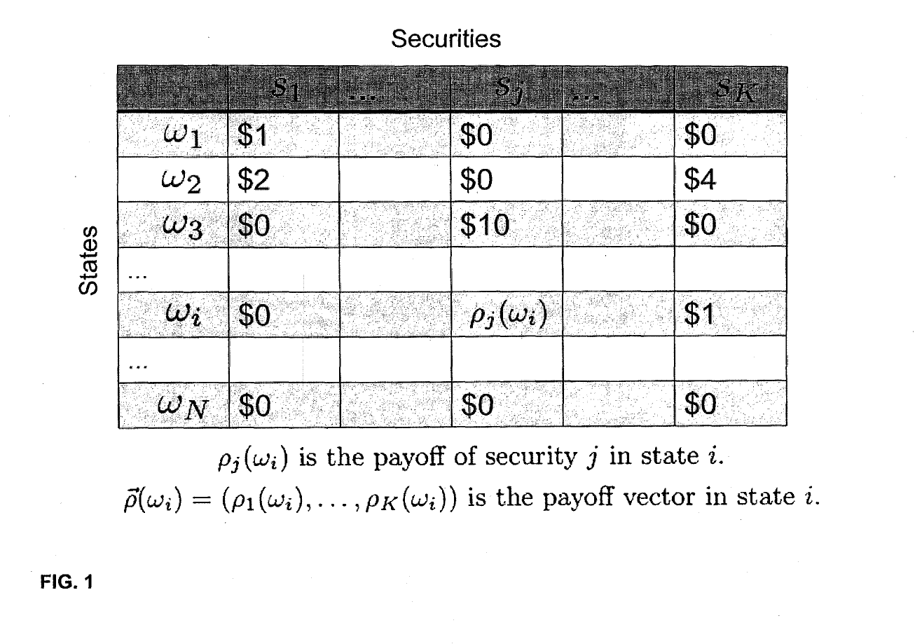

Each future state of the world may have a payoff associated with it. FIG. 1 illustrates this using K securities s₁, . . . , s_{K}. In the illustrative example of FIG. 1, there are N different states of the “world” and participants in the prediction market, based on these K securities, may place bets on any one of the N world states. The table shown in FIG. 1 illustrates payoffs for each security as a function of the future outcome (i.e., state of the world). For instance, the first security s₁ pays $1 in state ω₁ and $2 in state ω₂, but pays $0 in all the other states. Similarly, security s_{K} pays $4 in state ω₂, $1 in state ωᵢ, and $0 in all the other states. More generally, ρⱼ(ωᵢ) is the payoff of security j in state i. Each row of the table shown in FIG. 1 may be thought of as a vector in Euclidean space and is referred to as the “payoff vector.” For example, the payoff vector associated with state ω₁ is a 1×K vector (1, 0, 0, . . . , 0) consisting of a one followed by K−1 zeros. Note that the securities shown in FIG. 1 are security bundles since they allow market participants to bet simultaneously on multiple outcomes. For instance, security s₁ allows a market participant to simultaneously bet on the first two states (ω₁ and ω₂) and security s_{K} allows a market participant to simultaneously bet on state ω₂ and state ωᵢ.

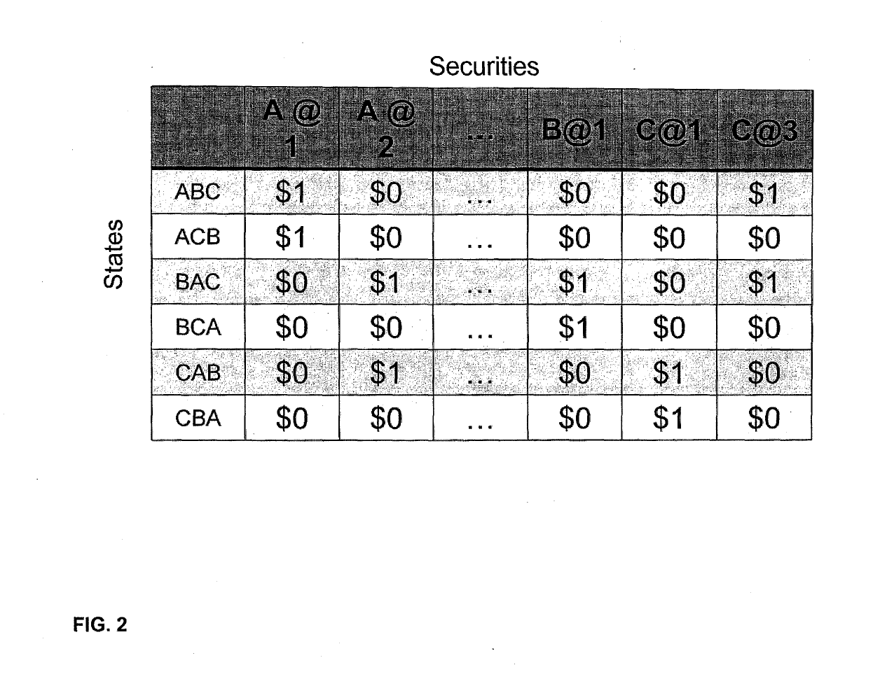

FIG. 2 illustrates the payoff structure for a set of security bundles in a prediction market, which supports betting on rankings. The market allows bets to be placed on the ranking (placement) of N competitors in a competition. For clarity of illustration, FIG. 2 illustrates securities with respect to outcomes concerning the rankings of three competitors. Though, the number of competitors may be any suitable number such as 2, 3, 4, 5, 10, 25, 50, 100, 250, 500, 1000, 5000, 10000, or any other suitable number.

In the example of FIG. 2, three competitors A, B, and C are competing. One may operate a prediction market comprising security bundles that allows market participants to place simultaneous bets on multiple rankings. For instance, the security bundle A@1 covers all outcomes in which competitor A finishes first—as shown, there are two such outcomes (ABC and ACB). Similarly, one may bet on competitor B finishing first or second, competitor C finishing first or second, and so on. FIG. 2 also shows an example set of payoff vectors (rows of the illustrated matrix) associated with the six possible outcomes. Payoffs for each of the security bundles may be computed from the payoff vectors. Though, FIG. 2 shows a set of security bundles for betting on the ranking of three competitors, one may operate a ranking prediction market for betting on outcomes on a competition among N competitors where N is any suitable number. In this case, the security bundle A@1 (where A is one of the N competitors) would allow market participants to simultaneously bet on exponentially many outcomes (in this case (N−1)! outcomes because candidates other than candidate A may finish in any order). Conventional methods may require an exponential number of calculations to price the security A@1, in this case. This type of prediction market is sometimes referred to as a “subset betting.” Note that subset betting using a conventional approach known as the Logarithmic Market Scoring Rule (LMSR) is known to be computationally intractable and has, in fact, been shown to belong the #P (sharp P) complexity class.

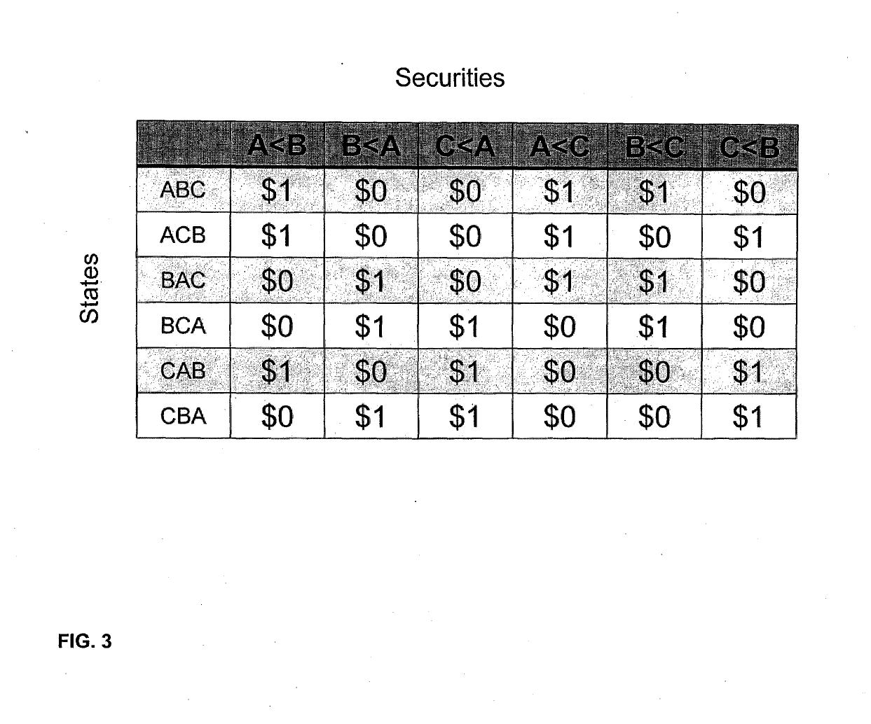

FIG. 3 shows another example set of security bundles for betting on outcomes of rankings among three competing candidates. In this case, market participants place bets on pairs of candidates and the relative placement of pair members in the ranking. For instance, the security bundle “A<B” allows a market participant to place a simultaneous bet on all outcomes (i.e., rankings) in which A finishes prior to B. Similarly, the security bundle “C<A” allows a market participant to place a simultaneous bet on all rankings in which C finishes prior to A. Though, FIG. 3 shows a set of security bundles for betting on the ranking of only three competitors, one may operate a ranking prediction market for betting on outcomes on a competition among N competitors. In this case, pairs betting using the Logarithmic Market Scoring Rule (LMSR) is known to also be computationally intractable and has also been shown to belong to the #P complexity class.

Some embodiments of the present invention may be used to design and operate prediction markets, such as the subset and pairs betting markets illustrated above in FIGS. 2 and 3. Though, these examples of prediction markets are not limiting on the invention and are merely illustrative. The disclosed techniques may be applied quite generally to any market in which bets are placed on outcomes such as financial markets and prediction markets. Still other examples of markets include a sphere betting market as described in greater detail below in Section VI.B.

In some embodiments, a market maker may design a prediction market to be operated by defining multiple security bundles that may be purchased and/or sold (i.e., traded) by market participants. Each security bundle may allow a market participant to simultaneously bet on one or multiple outcomes. For instance, the security bundle may comprise one or more financial derivatives. Another example of a security bundle may be a security bundle to place a bet on a subset of a large number of discrete outcomes such as outcomes in subset and/or pairs betting previously described with reference to FIGS. 2 and 3. These and other examples of security bundles are described in greater detail below in Sections VI.A and VI.B.

In some embodiments, the number of security bundles K defined by the market maker may be smaller than the number of outcomes N. For instance, there may be N=100 competitors in a competition, but only K=2 security bundles allowing one to bet on candidate A finishing first or candidate F finishing first. Though, in other embodiments, the number of security bundles K may be large and be greater than or equal to N.

The market maker may associate a payoff vector to each of the possible outcomes. Each payoff vector, corresponding to a particular outcome, may define the payoff associated with each security bundle for that outcome. Though, in some cases, a payoff vector may specify the payoff for only a subset of all security bundles for that outcome. The entries in payoff vector may be real numbers. Accordingly, payoffs in certain states of the world may be positive (indicating profit), negative (indicating loss), or 0 (indicating no profit or loss). In some embodiments, each outcome may have a unique payoff vector while in other embodiments, multiple outcomes may share a common payoff vector.

The set of all payoff vectors may be used to define a convex hull of the payoff vectors. As is known by those of ordinary skill in the art, a convex hull of a set of vectors may be defined as the set of all convex combinations of the vectors in the set.

A market maker may determine a price for each of the multiple security bundles by minimizing a conjugate function over a convex set comprising the convex hull of at least a subset of the set of payoff vectors. The convex set may be any suitable convex set. In some instances, the convex set may be a superset of the convex hull of at least a subset of the set of payoff vectors, while in other instances the convex set may be the same set as this convex hull.

In some embodiments, the convex set and/or the convex hull may be represented by a number of inequality constraints. The inequality constraints may be linear inequality constraints. The number of inequality constraints may be a polynomial function of K (number of security bundles) or may be a polynomial function of N (number of outcomes). Though, in some embodiments, the convex set or hull may be represented using an alternative representation. For instance, in the subset market described with respect to FIG. 2 and further described below in Section VI. B, the convex hull comprises a set of all N×N doubly stochastic matrices.

In some embodiments, a separation oracle may be employed. A separation oracle may be used to decide efficiently (i.e., in polynomial time) whether a point is in the convex set or not. Given such a separation oracle one has access to a variety of computationally-efficient (i.e., polynomial-time) methods for minimizing a convex function over the convex set. For instance, Khachiyan's ellipsoid method may be employed. Separation oracles are described in more detail in Section VII below.

The conjugate function to be minimized over the convex set may be any suitable convex function. For instance, the conjugate function may be any of numerous convex information-theoretic measures such as relative entropy. Alternatively, the conjugate function may be an appropriately-defined norm function. For instance, the conjugate function may be the 1-norm, the 2-norm (i.e., Euclidean distance), or a p-norm where p is a prime number. More generally, any suitably-defined norm may be employed. Though it should be recognized that these examples are merely illustrative, and other convex functions will be apparent to those skilled in the art. The cost function may be the conjugate cost function R(x) as described in Sections II-V below.

A market maker may determine a price for each of the multiple security bundles by minimizing the convex conjugate function over the convex set. This is described in greater detail in Sections II-V below. Briefly, in this approach, the conjugate function is the conjugate function R. The market maker may determine a price for a security bundle q by solving the following optimization problem:

$${sup}_{x ∈ Π} x \cdot q - R ( x ) ,$$

where Π is the convex set comprising the convex hull of at least a subset of the set of payoff vectors, and sup denotes the supremum of a set. Though, the optimization problem may be formulated in other ways and the above formulation is merely illustrative.

Given a convex conjugate function and a convex set, any of numerous optimization methods may be used to minimize the convex conjugate function over the convex set. For instance, techniques from linear, quadratic, semi-definite and/or convex programming may be employed. Such techniques may be used to solve the optimization problem described in the above equation, for example. These techniques are well known in the art; they are also discussed greater detail below.

The inventors have recognized and appreciated that market makers may design and operate prediction markets such that the losses, which the market makers sustain, are limited. Accordingly, in some embodiments, the conjugate function and the convex set may be chosen such that the market-makers worst-case monetary loss is bounded. The loss may be the worst-case difference between the maximum amount that the market maker might have to pay the market participants (e.g., traders) and the amount of money collected by the market maker from the market participants. In some embodiments, if the convex conjugate function is minimized over the convex hull of the payoff vectors (i.e., the convex set comprising the convex hull is equal to the convex hull), then the worst-case monetary loss is bounded. Further details about and examples of worst-case monetary loss and methods for calculating monetary loss are described in Sections III and IV below.

The inventors have also recognized and appreciated that the above-described methods for designing a prediction market and pricing security bundles may be applied to operating prediction markets.

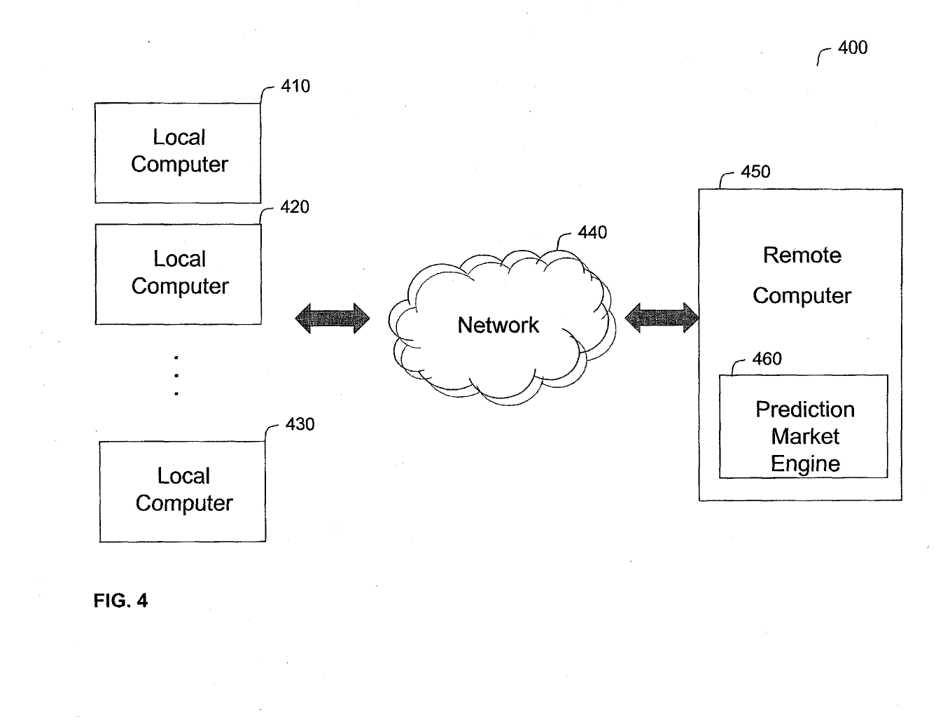

FIG. 4 shows an exemplary system 400 for trading security bundles, in accordance with some embodiments of the present disclosure.

Remote computer 450 (server) may be operated by a market maker operating a prediction market such as financial market and/or a betting market (e.g., subset and pairs betting markets) or any other suitable market. Remote computer 450 may be connected to a network 440 using a wireless or a wired connection. The network 440 may be any suitable network such as a local area network (LAN) or a wide area network or the Internet. Regardless of the type of network 440, remote computer 450 may be able to transmit and receive information (e.g., messages, commands, and acknowledgements) to and from any number of other computers, such as, for instance, computers owned, operated, or accessed by market participants. For example, in the illustration of FIG. 4, remote computer 450 may communicate with local computers 410, 420 and 430 via network 440. Note that the number of other computers that remote computer 450 may communicate with is not a limitation on the invention. Though not explicitly shown in FIG. 4, any of the computers or computer systems may comprise one or multiple computing devices such as desktop computers, rack-mounted computers, PDAs, tablets, mobile phones, and/or any other suitable computing devices.

Each of the local computers (e.g., computers 410, 420 and 430) may present an interface to one or more market participants that may be using the local computer. The interface may be a graphical user interface and may present to the user a menu or a list of security bundles that the user may purchase from the market maker and a price associated with each of the security bundles. The price may be a purchase price, strike price and may comprise a bid-ask spread. The interface may also be a text-based interface or a combination of text-based and graphical user interfaces. Though the details of such an interface are not a limitation on the present invention. A market participant may use the interface to obtain information from the market maker and to send information to the market maker.

In one exemplary embodiment, the user may receive security bundle and price information from the market maker via the interface. The user may further submit an order (or cancel an order) using the interface. The user may receive confirmation from the market maker that an order (or the cancellation) has been received and/or processed.

Remote computer 450 may comprise a prediction market engine to calculate, using at least one processor, a price for each security bundle in a plurality of security bundles. For example, the prediction market engine may operate to minimize a convex function over a convex hull (or a convex set containing the convex hull) of payoff vectors associated with possible outcomes in order to calculate prices for these security bundles. Remote computer 450 may comprise an output module (not shown) to output a set of security bundles along with the associated prices to market participants. For instance, remote computer 450 may use the output module to send the security bundles and associated prices to market participants who may be using local computers 410, 420 and 430 over network 440. Though, the precise way in which this information (i.e., security bundles and prices) is transmitted and/or presented to market participants is not a limitation on the present invention.

Remote computer 450 may comprise an input module (not shown) to receive one or more orders from one or more market participants. The input module may receive such orders over network 440 or using alternative input means. For instance, a market maker may manually provide order information to the input module using a keyboard, mouse, and/or voice input. Still other ways of inputting order information will be apparent to those of skill in the art.

The output module of the remote computer 450 may output a response to a market participant notifying the participant that their order has or has not been accepted. More generally, the output module may output any communication (confirmation, alert, update, etc.) that may be needed or useful in the course of operating a prediction market.

The above-described embodiments of the present invention can be implemented in any of numerous ways. For example, the embodiments may be implemented using hardware, software or a combination thereof. When implemented in software, the software code may be executed on any suitable processor or collection of processors, whether provided in a single computer or distributed among multiple computers.

It should be appreciated that a computer may be embodied in any of numerous forms, such as a rack-mounted computer, a desktop computer, a laptop computer, or a tablet computer. Additionally, a computer may be embodied in a device not generally regarded as a computer, but with suitable processing capabilities, including a Personal Digital Assistant (PDA), a smart phone or any other suitable portable or fixed electronic device.

Also, a computer may have one or more input and output devices. These devices may be used, among other things, to present a user interface. Examples of output devices that may be used to provide a user interface include printers or display screens for visual presentation of output, and speakers or other sound generating devices for audible presentation of output. Examples of input devices that may be used for a user interface include keyboards, microphones, and pointing devices, such as mice, touch pads, and digitizing tablets.

Such computers may be interconnected by one or more networks in any suitable form, including a local area network (LAN) or a wide area network (WAN), such as an enterprise network, an intelligent network (IN) or the Internet. Such networks may be based on any suitable technology and may operate according to any suitable protocol and may include wireless networks, wired networks, and/or fiber optic networks.

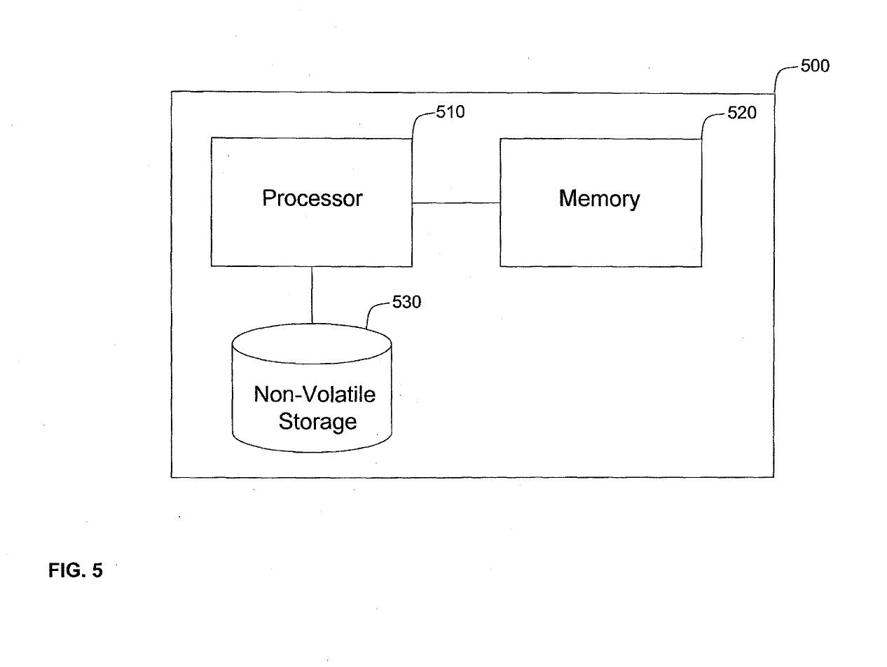

An illustrative implementation of a computer system 500 that may be used in connection with any of the embodiments of the invention described herein is shown in FIG. 5. The computer system 500 may include one or more processors 510 and one or more non-transitory computer-readable storage media (e.g., memory 520 and one or more non-volatile storage media 530). The processor 510 may control writing data to and reading data from the memory 520 and the non-volatile storage device 430 in any suitable manner, as the aspects of the invention described herein are not limited in this respect. To perform any of the functionality described herein, the processor 510 may execute one or more instructions stored in one or more computer-readable storage media (e.g., the memory 520), which may serve as non-transitory computer-readable storage media storing instructions for execution by the processor 510.

Provided below are additional details and examples related to the above-described embodiments. For convenience, they are organized using Section headings.

### I. Preliminaries

In some markets, a market maker may offer an Arrow-Debreu security corresponding to each potential outcome. Below, we consider a market-design scenario where the outcome space ◯ could potentially be quite large, or even infinite, making it potentially infeasible to run such a market. Instead, we allow the market maker to offer a menu of K securities for some reasonably-sized K, with the (nonnegative) payoff of each security described by an arbitrary but efficiently-computable function p:◯→R₊^{K}. Specifically, if a trader purchases a share of security i and the outcome is o, then the trader is paid ρᵢ(o). We call such security spaces complex. A complex security space reduces to the complete security space if K=|◯| and for each i∈{1, . . . K}, ρᵢ(o)=1 if o is the i th outcome and 0 otherwise. We consider traders that purchase security bundles r∈R^{K}. Negative elements of r encode sales. The payoff for r upon outcome o is exactly ρ(o)·r, where ρ(o) denotes the vector of payoffs for each security for outcome o. Let ρ(◯):={ρ(o)|o∈◯}.

### II. Designing a Cost Function Via Conjugate Duality

To design a market for a set of K securities with payoffs specified by an arbitrary payoff function ρ:◯→R₊^{K}, we should use a cost function based market with a convex, differentiable cost function such that {∇C(q):q∈R^{K}}=H(ρ(◯)). We now provide a general technique that may be used to design and compare properties of cost functions that satisfy these criteria. In order to accomplish this, we make use of tools from convex analysis.

It is well known in the art that any closed, convex, differentiable function C:R^{K}→R can be written in the form C(q)=sup_{x∈dom(R)}x·q−R(x) for a strictly convex function R called the conjugate of C, where dom(R) denotes the domain of R. (The strict convexity of R follows from the differentiability of C.) Furthermore, any function that can be written in this form is convex. The gradient of C can be expressed in terms of this conjugate: ∇C(q)=argmax_{x∈dom(R)}x·q−R(x). To generate a convex cost function C such that ∇C(q)∈Π for all q for some set Π, it is therefore sufficient to choose an appropriate conjugate function R, restrict the domain of R to Π, and define C as

$$C ( q ) = {sup}_{x ∈ Π} x \cdot q - R ( x ) .. \qquad ( 1 )$$

We call such a market a complex cost function based market. To generate a cost function C satisfying our five conditions, we need only to set Π=H(ρ(◯)) and select a strictly convex function R to serve as the conjugate.

This method of defining C may be convenient for several reasons. First, it leads to markets that are efficient to implement whenever Π can be described by a polynomial number of simple constraints. The difficulty with combinatorial outcome spaces is that actually enumerating the set of outcomes can be challenging or impossible. In our proposed framework we need only work with the convex hull of the payoff vectors for each outcome when represented by a low-dimensional payoff function ρ(·). This has significant benefits, as one often encounters convex sets which contain exponentially many vertices yet can be described by polynomially many constraints. Moreover, as the construction of C may be based on convex programming, we reduce the problem of automated market making to the problem of optimization for which we have a wealth of efficient algorithms. Second, this method yields simple formulas for properties of markets that help us choose the best market to run. Two of these properties, worst-case monetary loss and worst-case information loss, are analyzed below.

### III. Bounding Market Maker Loss and Loss of Information

Before discussing market properties, it is useful to review some helpful properties of conjugates. The first is a convenient duality: For any convex, closed function C, the conjugate of the conjugate of C is C itself. This implies that if C is defined as in Equation 1, we may write

$$R ( x ) = {sup}_{q ∈ {R}^{K}} q \cdot x - C ( q ) .$$

Since this maximization is unconstrained, the maximum occurs when ∇C(q)=x. (Note that this may hold for many different values of q.) Suppose for a particular pair (x*,q*) we have ∇C(q*)=x*. We can then rewrite this equation as R(x*)=q*·x*−C(q*), which gives us that C(q*)=q*·x*−R(x*). From Equation 1, this tells us that x* must be a maximizer of x·q−R(x). In fact, it is the unique maximizer due to strict convexity.) This implies, as mentioned above, that ∇C(q)=argmax_{x∈Π}x·q−R(x).

By a similar argument we have that for any q, if ∇R(x)=q then x maximizes x·q−R(x) and therefore, as we have just shown, x=∇C(q). However, the fact that x=∇C(q) does not imply that ∇R(x)=q; in the markets we consider, it is generally the case that x=∇C(q) for multiple q.

We will make use of the notion of Bregman divergence. The Bregman divergence with respect to a convex function ƒ is given by

D_{ƒ}(x,y):=ƒ(x)−ƒ(y)−∇ƒ(y)(x−y).

It is clear by convexity that D_{ƒ(x, y)≧}0 for all x and y.

Additionally, we will require notions like the interior and boundary of a convex set, yet we must introduce more careful terminology in order to consider the case that our price space is not of full rank. Given a convex set S⊂R^{d} that occupies d′ dimensions, where potentially d′<d, we define the relative interior of S, reling(S), which is the interior of S when restricted to the d′-dimensional space (typically known as the affine hull of S). In addition, we define the relative boundary of s, relbnd(S), as the set closure(S)\relint(S). With these tools in hand, we are ready to examine some market properties, and see how they depend on R.

When comparing market mechanisms, it may be useful to consider the market maker's worst-case monetary loss,

$${sup}_{q ∈ {R}^{K}} ( {sup}_{o ∈ O} ( ρ ( o ) \cdot q ) - C ( q ) + C ( ) ) .$$

This quantity is simply the worst-case difference between the maximum amount that the market maker might have to pay the traders (sup_{o∈◯}ρ(o)·q) and the amount of money collected by the market maker (C(q)−C( )). The following theorem provides a bound on this loss in terms of the conjugate function.

Theorem 1

Consider any complex cost function based market with H=H(ρ(◯)). The worst-case monetary loss of the market maker is no more than

$${sup}_{x ∈ ρ ( O )} R ( x ) - {inf}_{x ∈ H ( ρ ( O ) )} R ( x ) .$$

This theorem tells us that as long as the conjugate function is bounded on H(ρ(◯)), the market maker's worst-case loss is also bounded.

### IV. Bounding Information Loss

Information loss can occur when securities are sold in discrete quantities (for example, single units), as they are in most real-world markets. Without the ability to purchase arbitrarily small bundles, traders may not be able to change the market prices to reflect their true beliefs about the expected payoff of each security, even if expressiveness is satisfied. We will argue that the amount of information loss is captured by the market's bid-ask spread for the smallest trading unit. Given some q, the current bid-ask spread of security bundle r is defined to be (C(q+r)−C(q))−(C(q)−C(q−r)). This is the difference between the current cost of buying the bundle r and the current price at which r could be sold.

To see how the bid-ask spread relates to information loss, suppose that the current vector of quantities sold is q. If securities must be sold in unit chunks, a rational, risk-neutral trader will not buy security i unless she believes the expected payoff of this security is at least C(q+eᵢ)−C(q), where eᵢ is the vector that has value 1 at its i th element and 0 everywhere else. Similarly, she will not sell security i unless she believes the expected payoff is at most C(q)−C(q−eᵢ). If her estimate of the expected payoff of the security is between these two values, she has no incentive to buy or sell the security. In this case, it is only possible to infer that the trader believes the true expected payoff lies somewhere in the range [C(q)−C(q−eᵢ), C(q+eᵢ)−C(q)]. The bid-ask spread is precisely the size of this range.

The bid-ask spread depends on how fast instantaneous prices change as securities are bought or sold. Intuitively, the bid-ask spread relates to the depth of the market. When the bid-ask spread is large, new purchases or sales can change the prices of the securities dramatically; essentially, the market is shallow. When the bid-ask spread is small, purchases or sales may only move the prices slightly; the market is deep. We define a market depth parameter, β, for our complex securities markets with twice-differentiable C. Larger values of β correspond to deeper markets. We will bound the bid-ask spread in terms of this parameter, and use this parameter to show that there exists a clear tradeoff between worst-case monetary loss and information loss; this will be formalized in Theorem 2 below.

Definition 1

For any complex cost function based market, if C is twice-differentiable, the market depth parameter β(q) for a quantity vector q is defined as β(q)=1/V_{c}(q), where V_{c}(q) is the largest eigenvalue of ∇²C(q), the Hessian of C at q. The worst-case market depth is β=inf_{q∈R}_{^{K}}β(q).

Let relint (Π) be the relative interior of Π. If C is twice-differentiable, then for any q such that ΠC(q)∈relint(Π), we have a correspondence between the Hessian of C at q and the Hessian of R at ∇C(q). More precisely, we have that u^{T}∇²C(q)u=u^{T}∇⁻²R(∇C(q))u for any u=x−x′ with x,x′∈Π. This means that β(q) is equivalently defined as the smallest eigenvalue of Π²R(∇C(q))|_{Π}; that is, where we consider the second derivative only within the price region Π.

The definition of worst-case market depth implies that 1/β is an upper bound on the curvature of C, which implies that C is locally bounded by a quadratic with Hessian 1/β. We can derive the following.

Lemma 1

Consider a complex cost function based market with worst-case market depth β. For any q and r we have

$${D}_{C} ( q + r , q ) \leq \frac{{‖ r ‖}^{2}}{2 β}$$

It is easy to verify that the bid-ask spread can be written in terms of Bregman divergences. In particular, C(q+r)−C(q)−(C(q)−C(q−r))=D_{C}(q+r,q)+D_{C}(q−r,q). This implies that the worst-case bid-ask spread of a market with market depth β can be upper bounded by a constant times 1/β. That is, as the market depth parameter increases, the bid-ask spread must decrease. The following theorem shows that this leads to an inherent tension between worst-case monetary loss and information loss. Here diam(H(ρ(◯))) denotes the diameter of the hull of the payoff vectors for each outcome.

Theorem 2

For any complex cost function based market with worst-case market depth β, for any r, q meeting the conditions in Lemma 1, the bid-ask spread for bundle r with previous purchases q is no more than 2∥r∥²/β. The worst-case monetary loss of the market maker at least β·diam²(H(ρ(◯)))/8.

It may be seen that there is a direct tradeoff between the upper bound of the bid-ask spread, which shrinks as β grows, and the lower bound of the worst-case loss of the market maker, which grows linearly in β. This tradeoff is very intuitive. When the market is shallow (small β), small trades have a large impact on market prices, and traders cannot purchase too many shares of the same security without paying a lot. When the market is deep (large β), prices change slowly, allowing the market maker to gain more precise information, but simultaneously forcing the market maker to take on more risk since many shares of a security can be purchased at prices that are potentially too low. This tradeoff can be adjusted by scaling R, which scales β. This is analogous to adjusting the “liquidity parameter” b in the LMSR.

### V. Selecting a Conjugate Function

We have seen that the choice of the conjugate function R impacts market properties such as worst-case loss and information loss. We now explore this choice in more detail. In some embodiments, the conjugate may be a function of the form

$$R ( x ) := \frac{λ}{2} {‖ x - {x}_{0 } ‖}^{2} \qquad ( 2 )$$

Here R(x) is simply the squared Euclidean distance between X and an initial price vector x₀∈Π, scaled by λ. By utilizing this quadratic conjugate function, we achieve a market depth that is uniformly λ over the entire security space. Furthermore, if x₀ is chosen as the “center” of Π, namely

x₀=arg min_{x∈Π}max_{y∈Π}∥x−y∥,

then the worst-case loss of the market maker is max_{x∈Π}R(x)=(λ/8)diam²(Π). While the market maker can tune λ appropriately according to the desired tradeoff between worst-case market depth and worst-case loss, the tradeoff is tightest when R has a Hessian that is uniformly a scaled identity matrix, or more precisely where R takes the form in Equation 2.

Unfortunately, by selecting a conjugate of this form, or any R with bounded derivative, the market maker does inherit one potentially undesirable property: security prices may become constant when ΠC(q)) reaches a point at relbnd(Π) the relative boundary of Π. That is, if we arrive at a total demand q where ∇C(q)=)ρ(o) for some outcome o, our mechanism begins offering securities at a price equal to the best-case payoff, akin to asking someone to bet a dollar for the chance to possibly win a dollar.

To avoid these undesirable pricing scenarios, it is sufficient to require that our conjugate function satisfy one condition. We say that a convex function R defined on Π is a pseudo-barrier for Π if ∥∇R(xₜ)∥→∞ for any sequence of points x₁, x₂, . . . ∈Π which tends towards relbnd(Π). If we require our conjugate function R to be a pseudo-barrier, we are guaranteed that the instantaneous price vector ∇C(q) always lies in relint(Π), and does not become constant near the boundary.

It is important to note that, while it is desirable that ∥∇R(xₜ)∥→∞ as xₜ approaches relbnd(Π), it is generally not desirable that R(xₜ)→∞. Recall that the market maker's worst-case loss grows with the maximum value of R on Π and thus we should hope for a conjugate function that is bounded on the domain. A perfect example of convex function that is simultaneously bounded and a pseudo-barrier is the negative entropy function H(x)=ΣEᵢxᵢ log xᵢ, defined on the n-simplex ∇ₙ. It is perhaps no surprise that LMSR, the most common market mechanism for complete security spaces, can be described by the choice R(x):=λH(x) where the price space Π=∇ₙ.

### VI. Examples of Computationally Efficient Markets

We now provide some examples of markets that can be operated efficiently using this framework.

### VI.A Subset Betting

Consider the scenario in which the outcome is some ranking of a set of n competitors, such as n horses in a race. The outcome of such a race is a permutation π:[n]→[n], where π(i) is the final position of i, with π(i)=1 being best, and [n] denotes the set {1, . . . n}. A typical market for this setting might offer n Arrow-Debreu securities, with the i th security paying off if and only if π(i)=1. Additionally, there might be separate, independent markets allowing bets on horses to place (come in first or second) or show (come in first, second, or third). However, running independent markets for sets of outcomes with clear correlations is wasteful in that information revealed in one market does not automatically propagate to the others.

Subset betting relates to a situation in which traders can place bets (i, j), for any candidate i and any slot j, that pay out $1 in the event that π(i)=j and $0 otherwise. Using the above described framework, it is a computationally efficient market for securities of this form may be designed.

In order to set up such a combinatorial market within our framework, we must be able to efficiently work with the convex hull of the payoff vectors for each outcome. Notice that, for an outcome π, the associated payoff can be described by a matrix M_{π}, with M_{π}(i, j)=I[π(i)=j], where I[·] is the indicator function. Taking this one step further, it is easy to verify that the convex hull of the set of permutation matrices is precisely the set of doubly stochastic matrices, that is the set

$$Π = \{ X ∈ {R}_{\geq 0}^{n \times n} \text{:} {\sum }_{{i}^{′} = 1}^{n} X ( {i}^{′} , j ) = {\sum }_{{j}^{′} = 1}^{n} X ( i , {j}^{′} ) = 1 ∀ i , j \} ,$$

where X(i, j) represents the element at the i th row and j th column of the matrix X. Notice, importantly, that this set is described by only n² variables and O(n) constraints.

To fully specify the market maker, we may also select a conjugate function R for our price space. While the quadratic conjugate function is an option, there is a natural extension of the entropy function, for the space of stochastic matrices. For any X∈Π, let us set

$$R ( X ) = λ {\sum }_{i , j} X ( i , j ) log X ( i , j ) .$$

The worst-case market depth may be computed as the minimum of the smallest lint (II). eigenvalue of the Hessian of R within the relint(Π). This occurs at the matrix with all values 1/n, hence the worst-case depth may be nλ. The worst-case loss, on the other hand, may be computed as λn log n.

### VI.B. Sphere Betting

Herein another example of a market in which bets may be placed on outcomes in provided. In this example the outcome space is infinite. An object orbiting the planet, perhaps a satellite, is predicted to fall to earth in the near future and will land at an unknown location, which we would like to predict. We represent locations on the earth as unit vectors u∈R³. The difficulty of this example arises from the fact that the outcome must be a unit vector, imposing constraints on the three coordinates. We will design a market with three securities, each corresponding to one coordinate of the final location of the object. In particular, security i will pay off uᵢ+1 dollars if the object lands in to location u. (The addition of 1, while not strictly necessary, ensures that the payoffs, and therefore prices, remain positive, though it will be necessary for traders to sell securities to express certain beliefs.) This means that traders can purchase security bundles r∈R³ and, when the object lands at a location u, receive a payoff (u+)·r. Note that in this example, the outcome space is infinite, but the security space is small.

The price space H(ρ(◯)) for this market will be the 2-norm unit ball centered at 1. To construct a market for this scenario, let us make the simple choice of R(x)=λ∥x−1∥² for some parameter λ>0. When ∥q∥<2λ there exists an x such that ∇R(x)=q. In particular, this is true for x=(½)q/λ+1, and q·x−R(x) is minimized at this point. When ∥q∥>2λ, q·x−R(x) is minimized at an x on the boundary of H(ρ(◯)). Specifically, it is minimized at x=q/∥q∥+1. From this, we can compute

$$C ( q ) = \{ \begin{matrix}\frac{1}{4 λ} {‖ q ‖}^{2} + q \cdot 1 , & when ‖ q ‖ \leq 2 λ , \\ ‖ q ‖ + q \cdot 1 - λ , & when ‖ q ‖ > 2 λ\end{matrix} .$$

The market depth parameter β is 2λ; in fact, β(x)=2λ for any price vector x in the interior of H(ρ(◯)). By Theorem 3, the worst-case loss of the market maker is no more than λ, which is precisely the lower bound implied by Theorem 4. Finally, the divergence D_{C}(q+r, q)≦∥r∥²/(4λ)

for all q, r, with equality when ∥q∥, ∥q+r∥≦2λ, implying that the bid-ask spread scales linearly with

∥r∥²/λ.

### VII. Separation Oracles

As previously mentioned, in some embodiments, a separation oracle may be employed to decide in polynomial time whether a point is in a convex set or not. If we encounter a convex hull H(ρ(◯)) with exponentially-many constraints, all may not be lost. Recall that, in order to set prices, we need to solve the optimization problem max_{x∈H(ρ(◯))}q·x−R(x). Under certain circumstances this can still be solved efficiently.

Consider a convex optimization problem with a concave objective function ƒ(x) and constraints gᵢ(x)≦0 for all i in some index set I. That is, we want to solve:

$$max f ( x )$$

$$s . t . x ∈ {R}^{d} , {g}_{i} ( x ) \leq 0 ∀ i ∈ I$$

This may be converted to a problem with a linear objective in the standard way:

$$max c$$

$$s . t . x ∈ {R}^{d} , c ∈ R , f ( x ) \geq c , and {g}_{i} ( x ) \leq 0 ∀ i ∈ I$$

Of course, if I is an exponentially or infinitely large set it may not be feasible to solve this problem directly. On the other hand, the constraint set may admit an efficient separation oracle, defined as a function that takes as input a point (x, c) and returns true if all the necessary constraints are satisfied or, otherwise, returns false and specifies a violated constraint. Given an efficient separation oracle one has access to alternative methods for optimization known in the art, the most famous being Khachiyan's ellipsoid method, that run in polynomial time.

### VIII. Relaxation of the Price Space

When dealing with a convex hull H(ρ(◯)) that has a prohibitively large constraint set and does not admit an efficient separation oracle we still have one tool at our disposal: we can modify H(ρ(◯)) to get an alternate price space Π which we can work with efficiently.

We will continue to construct our markets in the usual way, via the tuple (◯, ρ, Π, R) where ◯ is the outcome space, P is the payoff function, Π⊂R^{d} is a convex compact set of feasible prices, and R:R^{d}→R is a strictly convex function with domain Π. The market's cost function C will be the conjugate of R with respect to the set Π, as in Equation 1. The only difference is that we now allow Π to be distinct from H(ρ(◯)). Not surprisingly, the choice of Π will affect the interest of the traders and the market maker. We prove several claims which will aid us in our market design. Theorem 53 tells us that the expressiveness condition should not be relaxed, while Theorem 4 tells us that the no-arbitrage condition can be. Together, these imply that we may safely choose Π to be a superset of H(ρ(◯)).

Theorem 3

For any complex cost function based market, the worst-case loss of the market maker is unbounded if ρ(◯)ÚΠ.

This theorem tells us that expressiveness is not only useful for information aggregation, it is actually necessary for the market maker to avoid unbounded loss. The proof involves showing that if o is the final outcome and ρ(o)∈Π, then it is possible to make an infinite sequence of trades such that each trade causes a constant amount of loss to the market maker.

In the following theorem, which may be viewed as an extension of Theorem 1, we see that including additional price vectors in Π does not adversely impact the market maker's worst-case loss, despite the fact that the no-arbitrage condition is violated.

Theorem 4

Consider any complex cost function based market with R and Π satisfying sup_{x∈H(ρ(◯))}R(x)<∞ and H(ρ(◯))⊂Π. Assume that the initial price vector satisfies ∇C( )∈H(ρ(◯)). Let q denote the vector of quantities sold and o denote the true outcome. The monetary loss of the market maker is no more than

$$R ( ρ ( O ) ) - {min}_{x ∈ H ( ρ ( O ) )} R ( x ) - {D}_{R} ( ρ ( O ) , ∇ C ( q ) ) .$$

Tis tells us that expanding Π can only help the market maker; increasing the range of ∇C(q) can only increase the divergence term. This may seem somewhat counterintuitive. We originally required that Π⊂H(ρ(◯0)) as a consequence of the no-arbitrage condition, and by relaxing this condition, we are providing traders with potential arbitrage opportunities. However, these arbitrage opportunities do not hurt the market maker. As long as the initial price vector lies in H(ρ(◯)), any such situations where a trader can earn a guaranteed profit are effectively created (and paid for) by other traders! In fact, if the final price vector ∇C(q) falls outside the convex hull, the divergence term will be strictly positive, improving the bound.

To elaborate on this point, let's consider an example where Π is strictly larger than H(ρ(◯)). Let q be the current vector of purchases, and assume the associated price vector x=∇C(q) lies in the interior of H(ρ(◯)). Consider a trader who purchases a bundle r such that the new price vector leaves this set, i.e., y:=∇C(q+r)∉H(ρ(◯)). We claim that this choice can be strictly improved in the sense that there is an alternative bundle r′ whose associated profit, for any outcome o, is strictly greater than the profit for r.

For simplicity, assume y is an interior point of Π\H(ρ(◯)) so that q+r=∇R(y). Define π(y):=arg min_{y′∈H(ρ(◯))}D_{R}(y′, y), the minimum divergence projection of y into H(ρ(◯)). The alternative bundle we consider is r′=∇R(π(y))−q. Our trader pays C(q+r)−Cq+r′) less to purchase r′ than to purchase r. Hence, for any outcome o, we see that the increased profit for r′ over r is

ρ(o)·(r′−r)−C(q+r′)+C(q+r)>ρ(o)·(r′−r)+∇C(q+r′)·(r−r′)=(ρ(o)−π(y))·(r′−r). (3)

Notice that we achieve strict inequality precisely because ∇C(q+r′)≠∇C(q+r). Now use the optimality condition for π(y) to see that, since ρ(o)∈H(ρ(◯)), ∇_{π(y)}(D_{R}(π(y),y))·(ρ(o)−π(y))≧0. It is easy to check that ∇_{π(y)}(D_{R}(π(y),y))=∇R(π(y))−∇R(y)=r′−r. Combining this last expression with the inequality above and (3) tells us that the profit increase is strictly greater than (ρ(o)−π(y))·(r′−r)÷0. Simply put, the trader receives a guaranteed positive increase in profit for any outcome o.

The next theorem shows that any time the price vector lies outside of ρ(o), traders could profit by moving it back inside. The proof uses a nice application of minimax duality for convex-concave functions.

Theorem 4

For any complex cost function based market, given a current quantity vector q₀ with current price vector ∇C(q₀)=x₀, a trader has the opportunity to earn a guaranteed profit of at least min_{x∈H(ρ(◯))}D_{R}(x,x₀).

In the case that x₀∈H(ρ(◯)), D_{R}(x, x₀) is minimized when x=x₀ and the bound is vacuous, as we would expect. The more interesting case occurs when the prices have fallen outside of H(ρ(◯)), in which case a trader is guaranteed a riskless profit by moving the price vector to the closest point in H(ρ(◯)).

### Pair Betting Via Relaxation

Let us turn our attention back to the scenario in which the outcome is a ranking of a set of n competitors, as previously described. Consider a complex market in which traders can make arbitrary pair bets: for every i, j, a trader can purchase a security which pays out if and only if π(i)>π(j). Like subset bets, pricing pair bets using LMSR is known to be #P-hard.

We can represent the payoff structure of any such outcome π by a matrix M_{π} defined by

$${M}_{π} ( i , j ) = \{ \begin{matrix}1 , & if π ( i ) > π ( j ) \\ \frac{1}{2} , & if i = j \\ 0 , & if π ( i ) < π ( j )\end{matrix} .$$

We would like to choose our feasible price region as the set H({M_{π}:π∈S_{n}), where S}ₙ is the set of permutations on [n]. Unfortunately, the computation of this convex hull is necessarily hard: if given only a separation oracle for the set H({M_{π}:π∈Sₙ}), we could construct a linear program to solve the “minimum feedback arc set” problem, which is known to be NP-hard.

On the positive side, we see from the previous section that the market maker can work in a larger feasible price space without risking a larger loss. We thus relax our feasible price region Π to the set of matrices X∈Rⁿ^{²} satisfying

X(i,j)≧0∀i,j∈[n]

X(i,j)=1−X(j,i)∀i,j∈[n]

X(i,j)+X(j,k)+X(k,i)≧1∀i,j,k∈[n]

By using this relaxed price space, the market maker allows traders to bring the price vector outside of the convex hull, yet includes a set of basic (and natural) constraints on the prices. Such a market could be implemented with any strongly convex conjugate function (e.g., quadratic).

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein, unless clearly indicated to the contrary, should be understood to mean “at least one.”

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items.

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A computer-implemented method of designing a prediction market, the method comprising:
defining a plurality of security bundles and a plurality of payoff vectors, wherein each payoff vector in the plurality of payoff vectors is associated with an outcome in a plurality of outcomes; and
determining, using at least one processor, a price for each security bundle in the plurality of security bundles by using at least one processor to minimize a convex function over a convex set comprising a convex hull of at least one vector in the plurality of payoff vectors.

2. The method of concept 1, wherein the convex set is equal to the convex hull of the at least one vector in the plurality of payoff vectors.

3. The method of concept 1, wherein the at least one vector in the plurality of payoff vectors comprises all the vectors in the plurality of payoff vectors.

4. The method of concept 1, wherein the determining further comprises:
representing the convex set using a number of linear inequality constraints, wherein the number is a polynomial function of a number of outcomes in the plurality of outcomes.

5. The method of concept 1, wherein the convex function is either a relative entropy function or a norm.

6. The method of concept 1, wherein a market maker operates the prediction market and the market maker's worst-case monetary loss is bounded.

7. The method of concept 1, wherein each outcome in the plurality of outcomes is a ranking of M competitors and each security bundle comprises a bet that competitor i is ranked at position j, where i and j are integers between 1 and M, inclusive.

8. The method of concept 7, wherein the convex hull is a set of all M by M doubly stochastic matrices.

9. At least one non-transitory computer-readable storage medium storing processor-executable instructions that, when executed by at least one processor, cause the at least one processor to perform a method of determining a price for each security bundle in a plurality of security bundles, the method comprising:
minimizing a convex function over a convex set comprising a convex hull of a plurality of payoff vectors,
wherein each payoff vector in the plurality of payoff vectors is associated with an outcome in a plurality of outcomes.

10. A computer-implemented method of operating a prediction market, the method comprising:
presenting, using at least one processor, a plurality of security bundles together with a price for each security bundle to a plurality of prediction market participants;
receiving, using the at least one processor, an order from a participant in the plurality of prediction market participants; and
sending, using the at least one processor, a response to the participant notifying the participant that the order has been accepted,
wherein each payoff vector in a plurality of payoff vectors is associated with at least one outcome in a plurality of outcomes and the price for each security bundle is determined by using the at least one processor to minimize a convex function over a convex set comprising a convex hull of the plurality of payoff vectors.

11. A system for operating a prediction market, the system comprising:
at least one processor configured to:
calculate a price for each security bundle in a plurality of security bundles by minimizing a convex cost function over a convex set comprising a convex hull of the plurality of payoff vectors, wherein each payoff vector in the plurality of payoff vectors is associated with an outcome in a plurality of outcomes;
output the plurality of security bundles together with the corresponding prices to a plurality of prediction market participants;
receive an order from a participant in the plurality of prediction market participants,
wherein the system is configured to output a response to the participant notifying the participant that the order has been accepted.
